(19) United States
(12) Patent Application Publication
(10) Pub. No.: US 2024/0035603 A1
(43) Pub. Date: Feb. 1, 2024

(54) INSERT TYPE PIPE CONNECTING DEVICE

(71) Applicant: JUNGWOO METAL IND. CO., LTD., Yangju-si, Gyeonggi-do (KR)

(72) Inventor: Kwang Won LEE, Yangju-si, Gyeonggi-do (KR)

(73) Assignee: JUNGWOO METAL IND. CO., LTD., Yangju-si, Gyeonggi-do (KR)

(21) Appl. No.: 17/606,762

(22) PCT Filed: Sep. 14, 2021
(86) PCT No.: PCT/KR2021/012500

§ 371 Date: Oct. 27, 2021

(30) Foreign Application Priority Data
Aug. 30, 2021 (KR) 10-2021-0114868

(51) Int. Cl. F16L 37/092

(52) U.S. Cl. CPC F16L 37/092

(57) ABSTRACT

An insert type pipe connecting device includes a fitting unit which includes a first body into which a first pipe is inserted and a second body which has a pipe insertion space therein together with the first body and into which a second pipe is inserted, and has opening portions formed at both ends, and includes extension portions having relatively larger inner diameters than the pipes in the first body and the second body; a sealing member which is inserted into the extension portion; a compression unit which is configured independently of the sealing unit in the extension portion; a backup unit which is formed in a ring shape and configured to surround the outer diameter of the first pipe or the second pipe in the extension portion; and a support unit which is coupled to the opening portion at a rear end of the extension portion.

### TECHNICAL FIELD

The present invention relates to an insert type pipe connecting device and more particularly, to an insert type pipe connecting device capable of maintaining tightness only by insertion without separate additional coupling and firmly connecting a pair of pipes to each other.

### BACKGROUND ART

In general, pipe connectors have been used to connect various types of pipes that are constructed in construction and civil engineering, and these pipe connectors are formed in various shapes according to the size and type of the pipe.

In the case of a large-diameter pipe connector, an accommodation space is formed inside a connector into which the pipe is inserted, and the accommodation space is provided with a water stop ring and a grip ring. Accordingly, the pipe is inserted into the connector and then the grip ring is compressed to penetrate into the outer surface of the pipe to fix the pipe.

However, in order to use the method, the connector is pressed using a separate fitting device capable of inserting the pipe to the pipe connector and some plastic deformation is generated to connect the pipe to the pipe connector.

However, when an additional operation is performed using a separate fitting device, there is a problem that the installation is inconvenient and required time and required cost are increased during the construction.

Therefore, there is a need for a method for solving these problems.

### DISCLOSURE

### Technical Problem

In order to solve the problems in the related art, an object of the present invention is to provide an insert type pipe connecting device capable of maintaining a water stop force and firmly fix pipes through a simple process of inserting the pipes to a fitting unit.

In addition, an object of the present invention is to provide a fitting apparatus for connecting pipes that is simple in configuration and easy to be installed.

The objects of the present invention are not limited to the aforementioned objects, and other objects, which are not mentioned above, will be apparent to those skilled in the art from the following description.

### Technical Solution

In order to achieve the object, there is provided an insert type pipe connecting device which includes a fitting unit which includes a first body into which a first pipe is inserted and a second body which has a pipe insertion space therein together with the first body and into which a second pipe is inserted, and has opening portions formed at both ends, and includes extension portions having relatively larger inner diameters than the pipes in the first body and the second body; a sealing member which is inserted into the extension portion and maintains airtight between the fitting unit and the first pipe or between the fitting unit and the second pipe; a compression unit which is configured independently of the sealing unit in the extension portion, has a contact portion formed along the inner diameter, and compresses and fixes the first pipe or the second pipe; a backup unit which is formed in a ring shape and configured to surround the outer diameter of the first pipe or the second pipe in the extension portion, and fixes the location of each of the sealing unit and the compression unit and simultaneously maintains an mutual distance; and a support unit which is coupled to the opening portion at a rear end of the extension portion and prevents the backup unit from being separated from the inside of the extension portion, wherein the first pipe or the second pipe is inserted through the opened opening portion of the fitting unit and fixed so that the circumference is surrounded by the sealing unit and the compression unit.

The insert type pipe connecting device may further include a guide unit which is formed along a circumference in at least a part between the compression unit and the first pipe or the second pipe and slips along a longitudinal direction of the first pipe or the second pipe to selectively control whether to contact the compression unit and the first pipe or the second pipe.

A plurality of compression units may be configured and disposed continuously disposed along a longitudinal direction of the first pipe or the second pipe.

The compression unit may be formed in a ring shape, have an inner diameter which is in contact with the outer diameter of the first pipe or the second pipe, and may be bent with an inclination in an opposite direction to the opening portion.

The guide unit may be formed to have a inclination in response to the bent shape of the compression unit and a bent inclined angle of the compression unit may be adjusted along a sliding direction of the guide unit so that whether to contact the first pipe or the second pipe is controlled.

The backup unit may include a first backup member which is disposed between the sealing unit and the compression unit to maintain a predetermined distance and fix the positions; and a second backup member which is disposed between the compression unit and the support unit to maintain a predetermined distance and fix the positions and is formed to surround the circumference of the guide unit in the extension portion.

The support unit may be formed in a ring shape to be disposed at the rear end of the backup unit, have an outer diameter fixed to be in contact with the inner surface of the extension portion, and have an inner diameter spaced apart from the first pipe or the second pipe so that the guide unit communicates with the outside.

The extension unit may have a separate fixing groove formed along the inner diameter so that a part of the circumference of the support unit is inserted to at least apart thereof to fix the location of the support unit.

The extension portion may include a first space which is extended with a relative larger inner diameter than the outer diameter of the first pipe or the second pipe in the insertion space, and a second space which is extended toward the opening portion continuously from the first space and formed to have a relatively larger inner diameter than the first space.

The fitting unit may further include a deformation prevention portion which is formed in the opening portion at the rear end of the extension portion and is bent in a radial form so that the outer diameter is increased to prevent the deformation.

At least one sealing unit may be formed to have elasticity, seated on the extension portion, and formed in a ring form.

A longitudinal section of the sealing unit may include a main sealing region having a predetermined shape.

The longitudinal section of the sealing unit may further include an auxiliary sealing region protruding outward from the main sealing region.

The pipe may be inserted into the insertion space while the sealing unit, the compression unit, and the backup unit are inserted into the extension portion.

### Advantageous Effects

The insert type pipe connecting device of the present invention for solving the above problems has the following effects.

First, there is an advantage of stably fixing the pipes by the compression unit and the sealing unit which are in contact with each pipe to be fixed to the fitting unit and greatly improving the airtight.

Second, since the pipes are simply inserted into the insertion space without having a separate fixing device and the like and simultaneously fixed by the sealing unit and the compression unit and the installation method is very easy, there is an advantage of dramatically reducing required time and cost during construction.

Third, the deformation prevention portion is formed in a form in which the thickness is extended along the circumference of the fitting unit to prevent the fitting unit from expanding the circumference direction or deforming the circumference shape, thereby supporting the pipes even though gas as well as a liquid flow in the pipe to rapidly generate the pressure change.

The effects of the present invention are not limited to the aforementioned effect, and other effects not mentioned above will be clearly understood to those skilled in the art from the description of the appended claims.

### DESCRIPTION OF DRAWINGS

FIG. 1 is a diagram illustrating an external appearance of an insert type pipe connecting device according to an embodiment of the present invention;

FIG. 2 is a diagram illustrating an internal structure of the insert type pipe connecting device according to an embodiment of the present invention;

FIG. 3 is a diagram illustrating an appearance of a fitting unit in the insert type pipe connecting device according to an embodiment of the present invention;

FIG. 4 is a diagram illustrating an appearance of a compression unit in the insert type pipe connecting device according to an embodiment of the present invention;

FIG. 5 is a diagram illustrating an appearance of a sealing unit in the insert type pipe connecting device according to an embodiment of the present invention;

FIG. 6 is a diagram illustrating a cross-sectional shape of a second sealing member of FIG. 5;

FIG. 7 is a diagram illustrating a state in which the sealing unit and a backup unit are inserted into the fitting unit in the insert type pipe connecting device according to an embodiment of the present invention;

FIG. 8 is a diagram illustrating a state in which the compression unit and a guide unit are inserted into the fitting unit of FIG. 7;

FIG. 9 is a diagram illustrating a state in which a support unit is coupled to the fitting unit FIG. 8;

FIG. 10 is a diagram illustrating a state in which a pipe is coupled to the fitting unit of FIG. 9; and

FIGS. 11 and 12 are diagrams illustrating a state in which an inclined angle of the compression unit is controlled by the guide unit in the insert type pipe connecting device according to an embodiment of the present invention.

### MODES FOR THE INVENTION

Hereinafter, a preferred embodiment of the present invention, of which an object of the present invention may be realized in detail, will be described with reference to the accompanying drawings. In describing the embodiment, like names and like reference numerals will be used with respect to like components and the resulting additional description will be omitted.

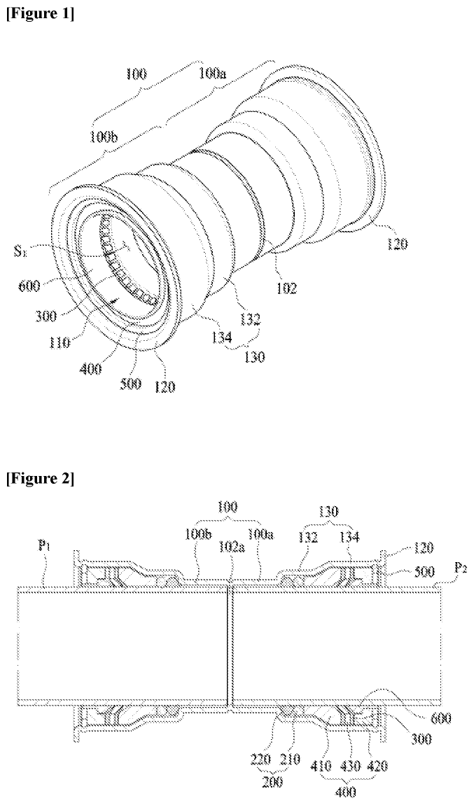

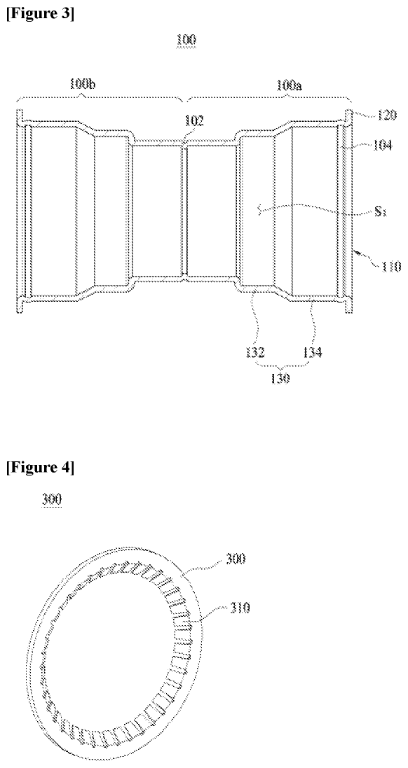

FIG. 1 is a diagram illustrating an external appearance of an insert type pipe connecting device according to an embodiment of the present invention, FIG. 2 is a diagram illustrating an internal structure of the insert type pipe connecting device according to an embodiment of the present invention, and FIG. 3 is a diagram illustrating an appearance of a fitting unit 110 in the insert type pipe connecting device according to an embodiment of the present invention.

As illustrated in FIGS. 1 to 3, an insert type pipe connecting device according to an embodiment of the present invention largely includes a fitting unit 100, a sealing unit 200, a compression unit 300, a backup unit 400, a support unit 500, and a guide unit 600.

The fitting unit 100 has an insertion space S1 of pipes P1 and P2 formed therein so that the different pipes P1 and P2 may be inserted into both sides, and an opening portion 110 which is entirely formed in a pipe shape and formed at both ends so as to pass though inner and outer portions.

Particularly, in the embodiment, the fitting unit 100 includes a first body 100a into which the first pipe P1 is inserted and a second body 100b into which the second pipe P2 is inserted. The first body 100a and the second body 100b have a symmetrical shape in both directions based on a central line of the fitting unit 100 and have the insertion space S1 of pipes P1 and P2 formed therein.

In addition, in each of the first body 100a and the second body 100b, an extension portion 130 having a relatively larger inner diameter than the pipes P1 and P2 is formed in a partial area, and in the extension portion 130, the sealing unit 200, the compression unit 300, the backup unit 400, the support unit 500, and the guide unit 600 are inserted and disposed to surround the circumference of the pipes P1 and P2.

At this time, the extension portion 130 is formed so that the circumference is uniform or increased toward the opening portion 110 from the central portion of the fitting unit 100. In the embodiment, the extension portion 130 includes a first space 132 extended with a relatively larger inner diameter than an outer diameter of the pipes P1 and P2 in the insertion space S1 and a second space 134 extended toward the opening portion 110 continuously from the first space 132 and formed to have a relatively larger inner diameter than the first space 132.

In addition, the extension portion 130 is formed with a fixing groove 104 which is formed in a groove shape at a part of the inner diameter so that the support unit 500 is seated and fixed at a position adjacent to the opening portion 110. Here, the fixing groove 104 is seated in a forcibly fitting form when the extension portion 130 is inserted through the opening portion 110 to limit a movement in a lateral direction in the seated state and prevent the sealing unit 200, the compression unit 300, and the backup unit 400 from being separated to the outside in the extension portion 130.

As such, the fitting unit 100 is formed in a cylindrical shape and has the first body 100a and the second body 100b formed from the center to the outside direction, and in each of the first body 100a and the second body 100b, the extension portion 130 having an extended circumference is formed to receive the compression unit 300, the backup unit 400, and the support unit 500 therein.

Additionally, the fitting unit 100 according to the present invention is a connection means of the pipes P1 and P2 moving general fluids so that the pipes P1 and P2 are inserted into the insertion space and the fluid flows therein. At this time, in the embodiment, the fitting unit 100 allows a fluid in a gas form to flow along the pipes P1 and P2 and as a result, the deformation of the fitting unit 100 may be generated due to a pressure change.

However, the fitting unit 100 according to the present invention further includes a deformation prevention unit 120 which is bent in an extended form on the opening portion 110 to suppress the deformation of the fitting unit 100. Specifically, the fitting unit 100 is formed in the opening portion 110 at the rear end of each of the first body 100a and the second body 100b and bent in a radial form so that the outer diameter is increased.

At this time, the deformation prevention unit 120 is formed so that the thickness according to a circumference direction of the fitting unit 100 is extended to prevent the fitting unit 100 from expanding the circumference direction or deforming the circumference shape, and as a result, in the pipes P1 and P2, a liquid fluid and gas flow to support the pipes even though the pressure change rapidly occurs.

As such, according to the present invention, the fitting unit 100 has the extension part 130 formed at each of the first body 100a and the second body 100b and includes the deformation prevention units 120 at both ends to maintain the shape by suppressing the deformation even though the internal pressure is changed while the pipes P1 and P2 are inserted and fix the sealing unit 200, the compression unit 300, the backup unit 400, and the support unit 500 so as not to be separated.

In addition, a ring-shaped protrusion 102 protruding by a predetermined height may be formed on the inner circumferential surface of the center of the fitting unit 100 in which the first body 100a and the second body 100b are connected to each other. This is to limit a maximum insertion depth of the first pipe and the second pipe.

Next, the composition of the compression unit 300 and the sealing unit 200 will be described below with reference to FIGS. 4 to 6.

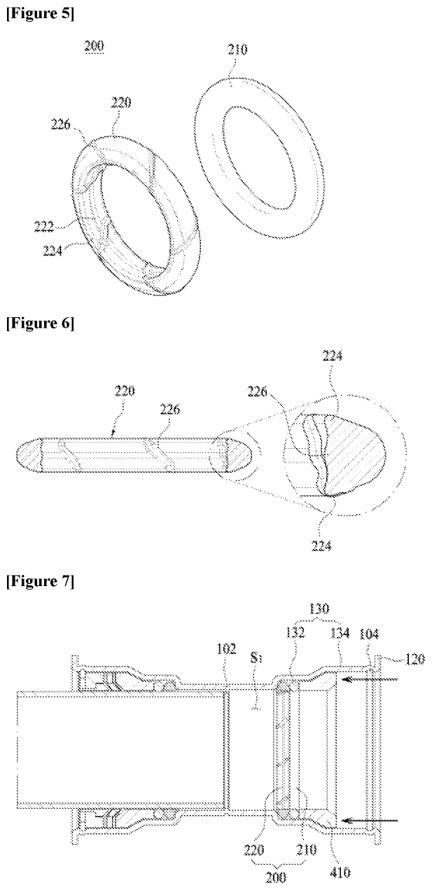

FIG. 4 is a diagram illustrating an appearance of a sealing unit 200 in the insert type pipe connecting device according to an embodiment of the present invention, FIG. 6 is a diagram illustrating a cross-sectional shape of a second sealing member of FIG. 5, and FIG. 6 is a diagram illustrating an appearance of the compression unit 300 in the insert type pipe connecting device according to an embodiment of the present invention.

First, the sealing unit 200 is a component which is provided in the extension portion 130 and in contact with the first pipe P1 or the second pipe P2 while compressing to prevent the flow of the fluid and maintain the airtight.

The reason why the sealing unit 200 is provided inside the compression unit 300 described above is to prevent a fluid flowing between the first pipe P1 or the second pipe P2 from being leaked toward the compression unit 300. That is, the sealing unit 200 is provided close to the center side of the fitting unit 100 and serves to prevent the leakage of the fluid in advance.

As illustrated in FIG. 5, the sealing unit 200 is formed to have elasticity, seated on the extension portion 130, and formed in a ring shape as a whole.

At this time, a plurality of sealing units 200 is configured and continuously disposed and may be configured to surround the pipes P1 and P2. Here, the sealing unit 200 has a circular cross section and formed in a ring shape or configured to have various cross-sectional shapes to increase airtight.

In the embodiment, the sealing unit 200 is configured to include a first sealing portion 210 having a ring-shaped cross section and a second sealing portion 220 including a separate protrusion, respectively, and the first sealing portion 210 and the second sealing portion 220 may be disposed continuously adjacent to each other.

Specifically, the first sealing portion 210 has a circular cross-sectional shape as illustrated in the drawings and is formed in a uniform ring shape, seated on the extension portion 130, and configured to surround the pipes P1 and P2. In addition, the second sealing portion 220 has a shape including an auxiliary sealing protrusion 226 protruding along an outer surface in a spiral shape. The auxiliary sealing protrusion 226 is to allow the second sealing portion 220 and the fitting unit 100 to have a greater water stop force between the first pipe P1 or the fitting unit 100 and the second pipe P2.

In addition, the longitudinal section of the sealing unit 220 may include a main sealing region 222 having a predetermined shape and an auxiliary sealing region 224 protruding outward from the main sealing region 222.

In the embodiment, the main sealing region 222 is formed to have a circular shape, and the auxiliary sealing region 224 has a shape in which a pair of auxiliary sealing regions protrudes to both sides of the main sealing region 222. Such a longitudinal section shape allows the sealing unit 200 to be more strongly in close contact with the first pipe P1 or the second pipe P2, thereby improving the water stop force.

In general, the pipes P1 and P2 may be scratched during use in manufacturing, transportation, and construction sites, and an allowable range thereof is 22% of a tube thickness. However, since the pipe is sensitive to the water stop force and the durability when applied to an actual product, there is a problem that it is difficult to maintain a desired water stop force when the pipe has a scratch of 22% thickness.

Particularly, a refrigerant (such as helium) used in an air conditioning system among fluids passing through the pipes P1 and P2 is sensitive to scratches, thereby increasing a possibility of leakage.

As a result, 22%-thick scratches are not allowed during the use of actual products, but more stringent standards are applied.

However, since the auxiliary sealing region 224 and the auxiliary sealing units 200 and 226 are provided together with the main sealing region 222 like the second sealing unit 220 of the present invention, the compressive force with the pipes P1 and P2 may be increased to maintain the water stop force.

That is, the present invention has an effect of maintaining the water stop force even if there are scratches on the pipes P1 and P2.

As such, according to the present invention, the sealing unit 200 may be configured to include the first sealing portion 210 and the second sealing portion 220, and is disposed at a position adjacent to a region where the first body 100a and the second body 100b are contacted in the first space 132 to increase the water stop force with the first pipe P1 and the second pipe P2.

In addition, the sealing unit 200 may use only one of the first sealing portion 210 or the second sealing portion 220, and unlike this, only a plurality of the same members may be configured to be used.

Meanwhile, the compression unit 300 is disposed in a ring form in the extension portion 130 and a part of the inner diameter is in contact with the compression unit 300 to press and fix the first pipe P1 or the second pipe P2.

Specifically, the compression unit 300 is formed in a ring shape and has a plurality of contact portions 310 formed continuously along the inner diameter and the contact portion 310 is formed in a protrusion shape to be inclined at a predetermined angle and disposed toward a concentric circle. At this time, the compression unit 300 may be formed of a metallic material, and the first pipe P1 or the second pipe P2 is plastically deformed by the compression unit 300 to be fixed so as not to be separated from the fitting unit 100.

Here, the compression unit 300 is disposed in a second space 134 of the extension portion 130 and the contact portion 310 is formed to be inclined toward an opposite direction to the opening portion 110. In addition, the inclined angle of the contact portion 310 is controlled by the guide unit 600 to be described below and selectively, whether to be contacted with the pipes P1 and P2 may be controlled.

More specifically, the compression unit 300 is formed in a ring shape and formed with the contact portions 310 with inclinations along the inner diameter to protrude toward the center, and when the first pipe P1 or the second pipe P2 is inserted into the fitting unit 100, the contact portions 310 are formed to have inclinations in an opposite direction to the opening portion 110 so as to prevent the interference with the contact portion 310.

In the embodiment, a pair of compression units 300 is configured to be spaced apart from each other, and disposed in a state in which the interval is kept by the backup unit 400 to be described below.

At least one compression unit 300 configured as such is provided in the extension portion 130 and disposed to be spaced apart from the sealing unit 200 at a predetermined distance to compress and fix the outer surfaces of the pipes P1 and P2 to be inserted. At this time, when a plurality of compression units 300 is configured, it is preferred that the compression units 300 are disposed continuously along the extension portion 300, but are disposed at predetermined intervals.

Meanwhile, the backup unit 400 is provided in the extension portion 130 and configured to fix the sealing unit 200, the compression unit 300, and the support unit 500 to be described below so as to be kept without departing from predetermined locations, and is configured in a ring shape to surround the outer diameters of the pipes P1 and P2 in the extension portion 130.

At this time, the backup unit 400 is formed differently in the size and shape of the outer diameter according to a seated position and is formed in a form of filling an empty space with a shape corresponding to the inner diameter shape of the extension portion 130.

Specifically, at least one or more backup units 400 are configured to be disposed continuously each other or spaced apart from each other to fix the position of the compression unit 300 and the sealing unit 200 in the receiving space.

Particularly, in the embodiment, the backup unit 400 is configured by three members including a first backup member 410, a second backup member 420, and a third backup member 430. The first backup member 410 is configured to be disposed between the sealing unit 200 and the compression unit 300 to maintain a predetermined distance and fix the positions and the second backup member 420 is disposed between the compression unit 300 and the support unit 500 to fix the position. Here, the second backup member 420 is disposed so that at least a part surrounds the guide unit 600 to be described below as described in the drawings.

In addition, the third backup member 430 is disposed between a pair of compression units 300 to maintain a separation distance between the compression units 300.

As such, the plurality of backup units 400 is configured to fill the inside of the extension portion 130 and disposed among the sealing unit 200, the compression unit 300 and the support unit 500 to prevent a change in mutual location and maintain the correct position.

In the embodiment, the backup unit 400 was configured by three of the first backup member to the third backup member 430, but may be configured in relatively less number or more number.

Meanwhile, the support unit 500 is a configuration which is disposed adjacent to the opening portion 110 to prevent members inserted into the extension portion 130 from being separated to the outside and is formed in a ring shape to be disposed at the rear end of the backup unit 400 and has an outer diameter fixed to be in contact with the inner surface of the extension portion 130.

Here, the support unit 500 has a ring shape with a predetermined thickness, wherein an outer diameter is inserted and fixed into the inner surface of the extension portion 130, and an inner diameter is configured to have a size larger than or equal to the pipes P1 and P2 to block a part of the opening portion 110. At this time, the inner diameter of the support unit 500 is larger than the outer diameter of the first pipe P1 or the second pipe P2 so as not to interfere with each other when inserting the pipes P1 and P2.

Specifically, the support unit 500 is coupled to a position adjacent to the opening portion 110 while the sealing unit 200, the compression unit 300, the guide unit 600, and the backup unit 400 all are inserted into the extension portion 130, and spaced apart from the first pipe P1 or the second pipe P2 to be coupled to be communicable with the outside. Here, the extension portion 130 has a separate fixing groove 104 formed along the inner diameter so that a part of the circumference of the support unit 500 is inserted to at least a part thereof and the support unit 500 is seated on the fixing groove 104 to be fixed into the extension 130.

At this time, the fixing groove 104 is formed to have a relatively large circumference in the second space 134 and the outer diameter of the support unit 500 is formed to correspond to the circumference of the fixing groove 104, so as to be fixed into the extension portion 130 in a forcibly fitted form when the support unit 500 is coupled.

Accordingly, the support unit 500 is fixed into the extension portion 130 at a position adjacent to the opening portion 110 and may allow the sealing unit 200, the compression unit 300, and the backup unit 400 to be maintained at the fixed positions.

Meanwhile, the guide unit 600 is provided at least partially between the compression unit 300 and the pipes P1 and P2 and formed along a circumference of the pipes P1 and P2 and slips along a longitudinal direction of the pipes P1 and P2 to selectively control whether to contact the compression unit 300 and the pipes P1 and P2.

The guide unit 600 is disposed along the circumference of the first pipe P1 or the second pipe P2 in the extension portion 130 and at least a part of the compression unit 300 is selectively in contact with the first pipe P1 or the second pipe P2 through the guide unit 600. At this time, the guide unit 600 is formed so that at least a part has a inclination in response to the bent shape of the compression unit 300 and a bent inclined angle of the compression unit 300 is adjusted along a sliding direction of the guide unit 600 so that whether to contact the pipes P1 and P2 is controlled.

Specifically, the guide unit 600 has at least one or more through grooves 610 formed along the circumference as illustrated in the drawings and the compression unit 300 is selectively in contact with the first pipe P2 or the second pipe P2 when the contact portion 310 passes through the through groove 610. Here, the through groove 610 is formed to have a downward inclination in response to the inclined angle of the contact portion 310 and while the guide unit 600 surrounds the first pipe P1 or the second pipe P2, the compression unit 300 surrounds the guide unit 600 so that apart of the inner diameter is inserted into the through groove 610.

In the embodiment, the guide unit 600 includes the through groove 610 corresponding to the number of compression units 300 and when the plurality of through grooves 610 is provided, the through grooves 610 are formed to have intervals corresponding to a separation distance between the compression units 300. As illustrated in the drawings, when two compression units 300 are configured, two through grooves 610 are also configured to be spaced apart from a longitudinal direction of the first pipe P1 or the second pipe P2.

In addition, since at least a part is extended along a longitudinal direction of the first pipe P1 or the second pipe P2, the guide unit 600 is configured to be exposed to the outside through the opening portion 110. At this time, as illustrated in the drawings, the second backup member 420 and the third backup member 430 are formed to surround a part of the guide unit 600 from the outside and fixed by the support unit 500.

The guide unit 600 configured as such is formed to be surrounded by the backup unit 400 along the longitudinal direction and configured to be slidably controlled by a predetermined distance along the longitudinal direction of the first pipe P1 or the second pipe P2.

That is, as illustrated in the drawings, the guide unit 600 is configured so that a front end is disposed adjacent to the first backup member 410 to have a downward inclination along a longitudinal direction and a rear end is surrounded by the second backup member 420, but has a partial circumference relatively smaller along the longitudinal direction and configured to be slidable. Here, the guide unit 600 is formed so that a front end has a downward inclination and a circumference of a rear end is relatively smaller, so that the guide unit 600 is not deviated from the extension portion 130 and movable along the longitudinal direction of the first pipe P1 or the second pipe P2.

As described above, in the pipe connecting device according to the present invention, a separate extension portion 130 is formed in the fitting unit 100 described above and while the sealing unit 200, the backup unit 400, the compression unit 300, and the support unit 500 formed in a ring shape are inserted and fixed, respectively, the first pipe P1 or the second pipe P2 is inserted into the insertion space through the opening portion 110.

In addition, while the first pipe P1 or the second pipe P2 is inserted into the insertion space, the airtight is secured by the sealing unit 200 and the first pipe P1 or the second pipe P2 is fixed by the compression unit 300. At this time, the compression unit 300 is formed so that the contact portion 310 formed at a part of the inner diameter has a inclination in an opposite direction of the opening portion 110 so as to minimize the interference when inserting the first pipe P1 or the second pipe P2 and generate a slip.

Next, a process of coupling the pipes P1 and P2 to the pipe connecting device according to the present invention will be described below with reference to FIGS. 7 to 10.

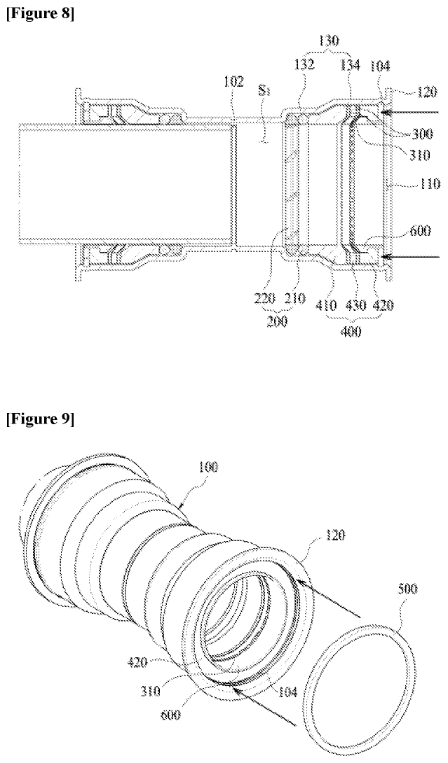

FIG. 7 is a diagram illustrating a state in which the sealing unit 200 and the backup unit 400 are inserted into the fitting unit 100 in the insert type pipe connecting device according to an embodiment of the present invention and FIG. 8 is a diagram illustrating a state in which the compression unit 300 and the guide unit 600 are inserted into the fitting unit 100 of FIG. 7.

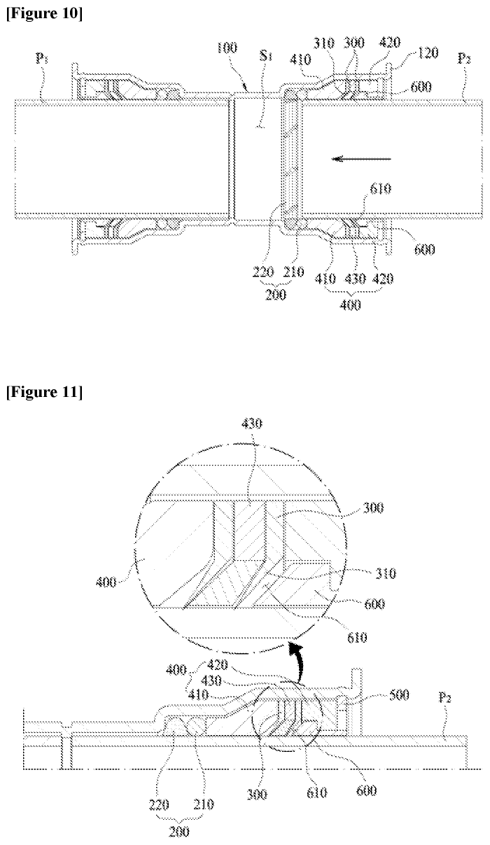

In addition, FIG. 9 is a diagram illustrating a state in which the support unit 500 is coupled to the fitting unit 100 FIG. 8 and FIG. 10 is a diagram illustrating a state in which the pipes P1 and P2 are coupled to the fitting unit 100 of FIG. 9.

First, as illustrated in FIG. 7, the sealing unit 200 and the backup member 410 are inserted into the pipes P1 and P2 through the opening portion 110. Here, the sealing unit 200 may be used in various shapes as illustrated in the drawing and in the embodiment, the first sealing portion 210 and the second sealing portion 220 are configured in a used form. Of course, unlike this, only either the first sealing portion 210 or the second sealing portion 220 may be configured.

As such, the sealing unit 200 is located inside the first space 132 in the extension portion 130, and accordingly, the sealing unit 200 is sealed with the pipes P1 and P2 when the pipes P1 and P2 are inserted and the fluid may be prevented from flowing into the extension portion 130 in reverse. As the first backup unit 400 is inserted, the sealing unit 200 is fixed into the extension portion 130.

Subsequently, referring to FIG. 8, the compression unit 300 and the guide unit 600 are inserted together and simultaneously, the third backup member 430 is inserted, and then the second backup member 420 is inserted into the rear end. Accordingly, the compression unit 300 and the guide unit 600 are arranged at a predetermined position and simultaneously, the guide unit 600 may be slidable within a certain range.

Thereafter, as illustrated in FIG. 9, the support unit 500 is inserted into the rear end of the second backup unit 400 and is inserted and fixed into the fixing groove 104. At this time, the support unit 500 is formed to correspond to the circumference of the inner diameter of the fixing groove 104 to have a relatively large outer diameter and is inserted through the opening portion 110 to be seated on the fixing groove 104 in a forcibly fitting form.

As such, in the fitting unit 100, while the sealing unit 200, the compression unit 300, the guide unit 600 and the backup unit 400 are inserted into the extension portion 130 and then fixed by the support unit 500, as illustrated in FIG. 10, the first pipe P1 or the second pipe P2 is inserted into the insertion space.

At this time, in the compression unit 300, the contact portion 310 passing through the through groove 610 has a downward inclination and contacts the outer surface of the first pipe P1 or the second pipe P2 to minimize interference when inserting the pipes and prevent the pipes from being separated in an opposite direction.

Accordingly, in the connecting device of the pipes P1 and P2 according to the present invention, there is no separate process after insertion of the pipes P1 and P2, and after all the components are disposed in the fitting unit 100 in advance, the first pipe P1 or the second pipe P2 is just inserted and then connected.

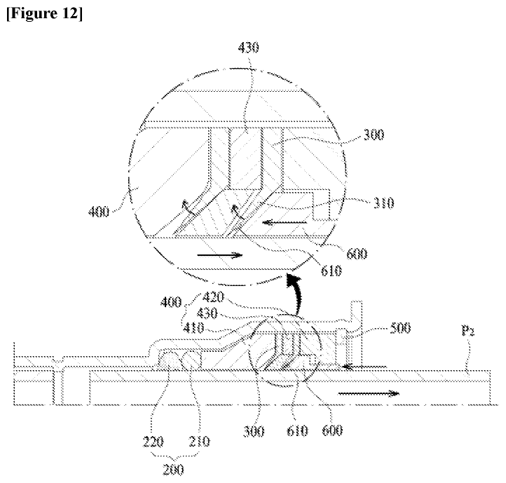

Then, as illustrated in FIGS. 11 and 12, a state in which the inclination angle of the compression unit 300 is adjusted by the guide unit 600 will be described as follows.

First, as illustrated in the drawings, the guide unit 600 slides forward and backward along the longitudinal direction and in conjunction with this, the inclination angle of the contact portion 310 of the compression unit 300 is adjusted.

Specifically, as illustrated in FIG. 11, the first pipe P1 or the second pipe P2 is inserted and coupled into the fitting unit 100, and at this time, the compression unit 300 is disposed so that the contact portion 310 has a downward inclination and the end portion is in contact with the first pipe P1 or the second pipe P2.

As such, when the first pipe P1 or the second pipe P2 moves to be discharged to the outside through the opening portion 110, the contact portion 310 penetrates into the outer surface of the first pipe P1 or the second pipe P2 to suppress the movement of the pipes P1 and P2.

That is, when the guide unit 600 does not perform a separate operation, the contact portion 310 is in contact with the outer surface of the first pipe P1 or the second pipe P2 to be prevented from being discharged.

However, as illustrated in FIG. 12, when the guide unit 600 slides in the opposite direction with the opening portion 110, the guide unit 600 presses the bending site of the compression unit 300 and the contact portion 310 is bent in the opposite direction with the opening portion 110.

As such, the contact portion 310 is bent in the opposite direction with the opening portion 110, the contact portion 310 is separated while being in contact with the outer surface of the first pipe P1 or the second pipe P2, and accordingly, a suppression force to suppress the first pipe P1 or the second pipe P2 from being separated from the fitting unit 100 is reduced.

That is, even if the first pipe P1 or the second pipe P2 is discharged in the direction of the opening portion 110, the contact with the compression unit 300 is released, and thus, the interference by the compression unit 300 disappears and the separation from the fitting unit 100 is enabled.

Accordingly, as illustrated in FIG. 11, while guide unit 600 is disposed slidably in the direction of the opening portion 110, the first pipe P1 or the second pipe P2 is in contact with the compression unit 300 and compressed, so that the separation is prevented. As illustrated in FIG. 12, while the guide unit 600 is disposed slidably in the opposite direction with the opening 110, the contact between the first pipe P1 or the second pipe P2 and the compression unit 300 is released to be easily separated from the fitting unit 100.

As described above, the prepared embodiment of the present invention has been as described, and in addition to the embodiments described above, a fact that the present invention can be materialized in other specific forms without departing from the gist or scope thereof will be apparent to those skilled in the art. Therefore, the aforementioned embodiments are not limited but should be considered to be illustrative, and accordingly, the present invention is not limited to the above description and may be modified within the scope of the appended claims and a range equivalent thereto.

1. An insert type pipe connecting device comprising:
a fitting unit which includes a first body into which a first pipe is inserted and a second body which has a pipe insertion space therein together with the first body and into which a second pipe is inserted, and has opening portions formed at both ends, and includes extension portions having relatively larger inner diameters than the pipes in the first body and the second body;
a sealing member which is inserted into the extension portion and maintains airtight between the fitting unit and the first pipe or between the fitting unit and the second pipe;
a compression unit which is configured independently of the sealing unit in the extension portion, has a contact portion formed along the inner diameter, and compresses and fixes the first pipe or the second pipe;
a backup unit which is formed in a ring shape and configured to surround the outer diameter of the first pipe or the second pipe in the extension portion, and fixes the location of each of the sealing unit and the compression unit and simultaneously maintains an mutual distance; and
a support unit which is coupled to the opening portion at a rear end of the extension portion and prevents the backup unit from being separated from the inside of the extension portion;
wherein the first pipe or the second pipe is inserted through the opened opening portion of the fitting unit and fixed so that the circumference is surrounded by the sealing unit and the compression unit.

2. The insert type pipe connecting device of claim 1, further comprising:
a guide unit which is formed along a circumference in at least a part between the compression unit and the first pipe or the second pipe and slips along a longitudinal direction of the first pipe or the second pipe to selectively control whether to contact the compression unit and the first pipe or the second pipe.

3. The insert type pipe connecting device of claim 2, wherein a plurality of compression units are configured and disposed continuously disposed along a longitudinal direction of the first pipe or the second pipe.

4. The insert type pipe connecting device of claim 2, wherein the compression unit is formed in a ring shape, has an inner diameter which is in contact with the outer diameter of the first pipe or the second pipe, and bent with an inclination in an opposite direction to the opening portion.

5. The insert type pipe connecting device of claim 4, wherein the guide unit is formed to have a inclination in response to the bent shape of the compression unit and a bent inclined angle of the compression unit is adjusted along a sliding direction of the guide unit so that whether to contact the first pipe or the second pipe is controlled.

6. The insert type pipe connecting device of claim 2, wherein the backup unit includes
a first backup member which is disposed between the sealing unit and the compression unit to maintain a predetermined distance and fix the positions; and
a second backup member which is disposed between the compression unit and the support unit to maintain a predetermined distance and fix the positions and is formed to surround the circumference of the guide unit in the extension portion.

7. The insert type pipe connecting device of claim 2, wherein the support unit is formed in a ring shape to be disposed at the rear end of the backup unit, has an outer diameter fixed to be in contact with the inner surface of the extension portion, and has an inner diameter spaced apart from the first pipe or the second pipe so that the guide unit communicates with the outside.

8. The insert type pipe connecting device of claim 1, wherein the extension portion has a separate fixing groove formed along the inner diameter so that a part of the circumference of the support unit is inserted to at least a part thereof to fix the location of the support unit.

9. The insert type pipe connecting device of claim 1, wherein the extension portion includes a first space which is extended with a relative larger inner diameter than the outer diameter of the first pipe or the second pipe in the insertion space, and a second space which is extended toward the opening portion continuously from the first space and formed to have a relatively larger inner diameter than the first space.

10. The insert type pipe connecting device of claim 1, wherein the fitting unit further includes a deformation prevention portion which is formed in the opening portion at the rear end of the extension portion and is bent in a radial form so that the outer diameter is increased to prevent the deformation.

11. The insert type pipe connecting device of claim 1, wherein at least one sealing unit is formed to have elasticity, seated on the extension portion, and formed in a ring form.

12. The insert type pipe connecting device of claim 11, wherein a longitudinal section of the sealing unit includes a main sealing region having a predetermined shape.

13. The insert type pipe connecting device of claim 12, wherein the longitudinal section of the sealing unit further includes an auxiliary sealing region protruding outward from the main sealing region.

14. The insert type pipe connecting device of claim 1, wherein the pipe is inserted into the insertion space while the sealing unit, the compression unit, and the backup unit are inserted into the extension portion.
